(19) United States
(12) Patent Application Publication
(10) Pub. No.: US 2012/0116792 A1
(43) Pub. Date: May 10, 2012

(54) TERMINAL CALCULATING CARBON EMISSION, CARBON EMISSION MANAGEMENT SERVER AND CARBON MONITORING METHOD

(76) Inventors: Ji Young Lee, Seoul (KR); Doo Haeng Lee, Seoul (KR); Jin Seog Kim, Seoul (KR); Jong Min Shin, Seoul (KR)

(21) Appl. No.: 13/382,808

(22) PCT Filed: Jul. 15, 2010
(86) PCT No.: PCT/KR2010/004609

§ 371 Date: Jan. 6, 2012

(30) Foreign Application Priority Data
Jul. 15, 2009 (KR) 10-2009-0064524

(51) Int. Cl. G06Q 99/00; G06F 7/38

(52) U.S. Cl. 705/1.1; 708/235

(57) ABSTRACT

A terminal is provided, the terminal comprising: a display unit configured to display information that is processed; a user input unit configured to input information on amount of carbon emission; a storage stored with information on the amount of carbon emission inputted through the user input unit and a program for calculating the amount of carbon emission; and a controller configured to calculate the amount of carbon emission based on usage of carbon emission and to display the amount of carbon emission on the display unit.

### TECHNICAL FIELD

The present disclosure relates to a terminal configured to calculate carbon emission, and more particularly to a terminal configured to calculate and accumulate carbon dioxide (Co²) emission caused by activity of a terminal user.

### BACKGROUND ART

The Kyoto Protocol adopted in 1997 introduced a peculiar amendment to the United Nations international treaty on global warming in which participating nations commit to reducing their emissions of green gas such as carbon dioxide (Co²), the amendment or the peculiar system being known as Emission Trading for providing a compulsory reduction obligation and inducing flexible implementation of green gas to the industrial countries.

The system sets a limit or a cap on the total amount of a green gas around the world that can be emitted. The limit or cap is allocated or sold to countries in order to reduce the emission of green gas such as methane gas, carbon dioxide or the like. That is, if a country emits green gas less than an allocated amount, the un-emitted amount of green gas can be traded to other countries, whereas countries that have an excess of emission can buy the right to emit or discharge a specific volume of specific pollutant from less-emitted countries. In effect, the buyer is paying a charge for polluting, while the seller is being rewarded for having reduced emissions. Thus, in theory, those who can reduce emissions most cheaply will do so, achieving the pollution reduction at the lowest cost to society.

The most emitted gas among the pollutants is carbon dioxide, such that the Emission Trading is generally called ‘carbon trade’, the transfer of permits being referred to as a trade. Although the emission allocation is provided to countries, those who actually suffer from emission of pollutants are firms that do the industrial activities, and the carbon trades are being implemented among industrial firms.

Woods or forests are recognized as having values as carbon emission rights or permits due to their capability to absorb and clean the pollutants. The carbon emission rights are already formed in European countries, and as countries like Australia and New Zealand have the rights to increase the carbon emission, they can sell the rights or permits to other countries.

Even in Korea, FKI (Federation of Korean Industries) and Korea Energy Management Corporation are trying to implement the Emission Trading on a joint base. There is no movement yet for individuals to be allocated with rights or permits, but if the environmental problems get serious, there is a likelihood of the Emission Trading being allocated to individuals.

### DISCLOSURE OF INVENTION

### Technical Problem

Although individuals are not allocated with the rights, recent interests in environmental hazards may induce an individual to be curious about emission of carbon dioxide he or she may emit.

Therefore, The present disclosure is to provide a terminal configured to easily calculate carbon emission, and a carbon monitoring method that is performed by the terminal.

### Solution to Problem

In one general aspect of the present disclosure, a terminal is provided, the terminal comprising: a display unit configured to display information that is processed; a user input unit configured to input information on amount of carbon emission; a storage stored with information on the amount of carbon emission inputted through the user input unit and a program for calculating the amount of carbon emission; and a controller configured to calculate the amount of carbon emission based on usage of carbon emission and to display the amount of carbon emission on the display unit.

In some exemplary embodiments of the present disclosure, the information on the usage of carbon emission may be usage information per item that emits carbon based on user activity, wherein the controller may use the usage information per item to calculate carbon emission per item, calculate an accumulated carbon emission per item for at least one period of a day period, a weekly period and a yearly period, and controllably display the accumulated carbon emission.

In some exemplary embodiments of the present disclosure, the terminal may further include a camera module configured to capture a carbon receipt that lists the carbon emission in a text or a bar code format, wherein the controller may calculate carbon emission relative to information related to the carbon emission read out by a text image or a bar code image captured by the camera module and controllably display the carbon emission on the display unit.

In some exemplary embodiments of the present disclosure, the terminal may further include information collector configured to receive information necessary for calculating the carbon emission from an outside server.

In some exemplary embodiments of the present disclosure, the outside server may be a settlement server that generates an electronic-type carbon emission receipt containing settlement breakdown information on purchase of goods or service that causes, by a user, the carbon emission, wherein the controller may calculate the carbon emission in real time using the settlement breakdown information in the carbon emission receipt received from the information collector and controllably display the calculation on the display unit.

In some exemplary embodiments of the present disclosure, the outside server may be an electric power use monitoring device configured to generate information on power usage in a household, or a gas use monitoring device configured to generate information on gas usage in a household, wherein the controller may use the information on power usage or the gas usage received from the information collector to calculate carbon emission in real time and to display the calculated carbon emission on the display unit.

In some exemplary embodiments of the present disclosure, the electric power use monitoring device configured to generate information on power usage in a household may be a smart meter, wherein the controller may use the information on the power usage received through the information collector from the smart meter to calculate the carbon emission, and generate a control command for controlling power equipment and transmit the control command to the smart meter, if the carbon emission exceeds a predetermined daily, weekly and monthly reference value.

In another general aspect of the present disclosure, a carbon emission management server is provided, the server comprising: a carbon emission database configured to receive at least one of settlement breakdown, power usage breakdown and gas usage breakdown per user from an outside server to calculate information on carbon emission per user on daily, weekly, monthly and yearly bases and to store/manage the information; a carbon emission allocation database configured to store/manage the information on carbon emission allocation per user in an account format based on carbon emission per user; and a controller configured to controllably transmit the information on the carbon emission allocation per user in an account format to a terminal of the user.

In some exemplary embodiments of the present disclosure, the settlement breakdown per user may be an electronic-type carbon emission receipt relative to purchase of goods or service that causes carbon emission per user generated by an outside settlement server.

In some exemplary embodiments of the present disclosure, the power usage breakdown per user may include power usage information based on whether to use carbon, wherein the carbon emission database may use the power usage information based on whether to use carbon to calculate the carbon emission.

In still another general aspect of the present disclosure, a carbon emission monitoring method, the method comprising: receiving information on carbon emission usage; calculating carbon emission based on the carbon emission usage; and displaying the carbon emission on a display unit.

In some exemplary embodiments of the present disclosure, the information on carbon emission usage may be usage information per item that emits carbon based on user activity, and the step of calculating the carbon emission based on the carbon emission usage may include using the usage information per item to calculate carbon emission per item and to calculate an accumulated carbon emission per item during any one period of daily, weekly, monthly and yearly periods.

In some exemplary embodiments of the present disclosure, the step of receiving information on carbon emission usage may include using a camera module to obtain a carbon receipt image in which the carbon emission is described in a text or bar code format, and the step of calculating the carbon emission based on carbon emission usage may include calculating carbon emission relative to information related to the carbon emission read out from a text image or a bar code image.

In some exemplary embodiments of the present disclosure, the step of receiving information on the carbon emission usage may include receiving information necessary for calculating carbon emission from an outside server.

In some exemplary embodiments of the present disclosure, the outside server may be a settlement server that generates an electronic-type carbon emission receipt containing settlement breakdown information on purchase of goods or service that causes, by a user, the carbon emission, and the step of calculating carbon emission based on carbon emission usage may include using the received settlement breakdown information on the carbon emission receipt to calculate the carbon emission in real time.

In some exemplary embodiments of the present disclosure, the power usage monitoring device generating information on power usage in a household may be a smart meter, and the step of calculating carbon emission based on carbon emission usage may include calculating carbon emission using the power usage information received from the smart meter, and the carbon emission monitoring method may further include: generating a control command for controlling power equipment; and transmitting the control command to the smart meter, if the calculated carbon emission exceeds predetermined daily, weekly and monthly reference values.

In still further general aspect of the present disclosure, a carbon emission monitoring method is provided, the method comprising: receiving at least one of settlement breakdown, power usage breakdown and gas usage breakdown per user from an outside server to calculate information on carbon emission per user on daily, weekly, monthly and yearly bases and to store/manage the information; storing/managing the information on carbon emission allocation per user in an account format based on carbon emission per user; and transmitting the information on the carbon emission allocation per user in an account format to a terminal of the user.

In some exemplary embodiments of the present disclosure, the settlement breakdown per user may be an electronic-type carbon emission receipt relative to purchase of goods or service that causes carbon emission per user generated by an outside settlement server.

In some exemplary embodiments of the present disclosure, the step of storing/managing the information on carbon emission allocation per user in an account format based on carbon emission per user may include deducting the calculated carbon emission per user from a predetermined carbon emission allocation per user.

In some exemplary embodiments of the present disclosure, the power usage breakdown per user may include power usage information based on whether to use carbon, wherein the carbon emission database may use the power usage information based on whether to use carbon to calculate the carbon emission.

### Advantageous Effects of Invention

The terminal thus configured according to the present disclosure has an advantageous effect in that the carbon emission caused by activity of a terminal user can be easily grasped.

### BRIEF DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of a mobile terminal according to an exemplary embodiment of the present disclosure;

FIG. 2 is a block diagram of a mobile terminal according to another exemplary embodiment of the present disclosure;

FIG. 3 is a screen of a display unit on a mobile terminal that sets up carbon emission calculation item;

FIG. 4 is a screen of a display unit on a mobile terminal that inputs carbon emission relative to carbon emission calculation item;

FIG. 5 is a screen of a display unit on a mobile terminal that warns carbon emission;

FIG. 6 is a screen of a display unit on a mobile terminal that outputs a detailed breakdown of carbon emission;

FIG. 7 is a screen of a display unit on a mobile terminal that outputs an accumulated carbon emission of a mobile terminal user;

FIG. 8 is a screen of a display unit on a mobile terminal that outputs a graph indicating a weekly carbon emission status;

FIG. 9 is a screen of a display unit on a mobile terminal that outputs a graph indicating a monthly carbon emission status;

FIG. 10 is a block diagram illustrating a mobile terminal and information collection structure according to still another exemplary embodiment of the present disclosure;

FIG. 11 is a block diagram illustrating a mobile terminal and information collection structure according to still further exemplary embodiment of the present disclosure;

FIG. 12 is a screen of a display unit on a mobile terminal that outputs carbon emission allocation and accumulated emission of a mobile terminal user;

FIG. 13 is a screen of a display unit on a mobile terminal that performs carbon emission allocation trading;

FIG. 14 is a block diagram illustrating a carbon emission management server and information collection structure according to still further exemplary embodiment of the present disclosure;

FIG. 15 is a flowchart illustrating a carbon emission monitoring method according to an exemplary embodiment of the present disclosure; and

FIG. 16 is a flowchart illustrating a carbon emission management method according to an exemplary embodiment of the present disclosure.

### MODE FOR THE INVENTION

A mobile terminal according to the present disclosure will be described in detail with reference to the accompanying drawings.

The suffixes ‘module’, ‘unit’ and ‘part’ may be used for elements in order to facilitate the disclosure. Significant meanings or roles may not be given to the suffixes themselves and it is understood that the ‘module’, ‘unit’ and ‘part’ may be used together or interchangeably.

Embodiments of the present disclosure may be applicable to various types of terminals. Examples of such terminals may include mobile terminals as well as stationary terminals, such as mobile phones, user equipment, smart phones, DTV, computers, digital broadcast terminals, personal digital assistants, portable multimedia players (PMP) and/or navigators.

A further description may be provided with regard to a mobile terminal, although such teachings may apply equally to other types of terminals such as stationary terminals that include digital TVs and desktop computers, the details of which are well known to the skilled in the art.

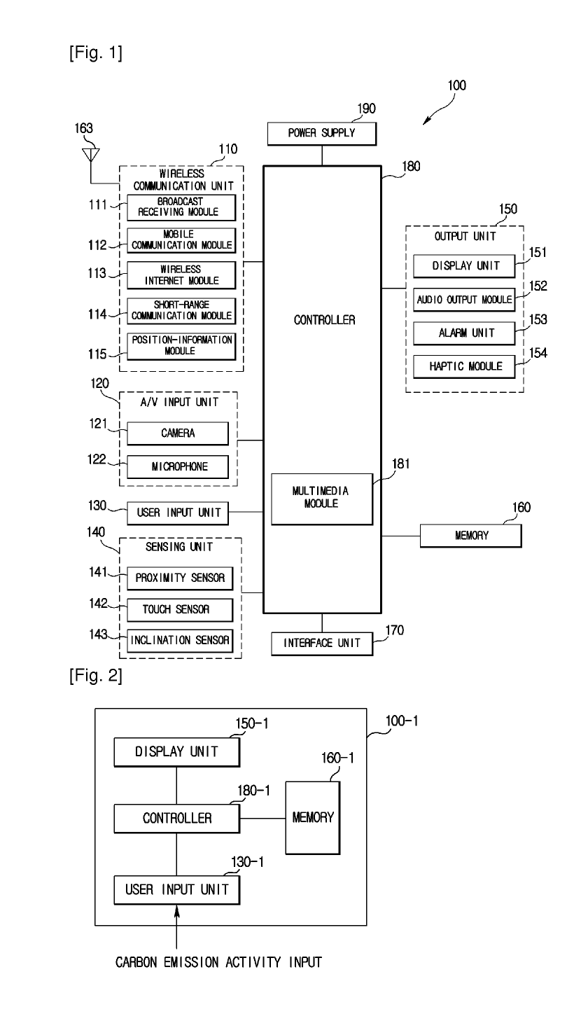

FIG. 1 is a block diagram of a mobile terminal in accordance with an example embodiment. Other embodiments and arrangements provided as constituent elements in FIG. 1 are not necessarily essential. FIG. 1 shows a mobile terminal 100 having various components, although other components may also be used. More or fewer components may alternatively be implemented.

FIG. 1 shows that the mobile terminal 100 includes a wireless communication unit 110, an audio/video (A/V) input unit 120, a user input unit 130, a sensing unit 140, an output unit 150, a memory 160, an interface unit 170, a controller 180 and a power supply unit 190. Hereinafter, the constituent elements will be sequentially described.

The wireless communication unit 110 may be configured with several components and/or modules. The wireless communication unit 110 may include a broadcast receiving module 111, a mobile communication module 112, a wireless Internet module 113, a short-range communication module 114 and a position-location module 115. The wireless communication unit 110 may include one or more components that permit wireless communication between the mobile terminal 100 and a wireless communication system or a network within which the mobile terminal 100 is located.

In case of non-mobile terminals, the wireless communication unit 110 may be replaced with a wire communication unit. The wireless communication unit 110 and the wire communication unit may be commonly referred to as a communication unit.

The broadcast receiving module 111 may receive a broadcast signal and/or broadcast associated information from an external broadcast managing server via a broadcast channel.

The broadcast channel may include a satellite channel and a terrestrial channel. The broadcast managing server may refer to a system that transmits a broadcast signal and/or broadcast associated information to a mobile terminal. The broadcasting signal may include not only a TV broadcasting signal, a radio signal, a data broadcasting signal, but also a broadcasting signal in which a TV broadcasting signal or a radio signal is combined with a data broadcasting signal.

Examples of broadcast associated information may include information associated with a broadcast channel, a broadcast program, a broadcast service provider, etc. The broadcast associated information may be provided through a mobile terminal. In this case, the broadcast associated information may be received by the mobile communication module 112.

For example, broadcast associated information may include an electronic program guide (EPG) of digital multimedia broadcasting (DMB) and an electronic service guide (ESG) of digital video broadcast-handheld (DVB-H).

The broadcast receiving module 111 may receive broadcast signals transmitted from various types of broadcast systems. As a non-limiting example, the broadcasting systems may include digital multimedia broadcasting-terrestrial (DMB-T), digital multimedia broadcasting-satellite (DMB-S), digital video broadcast-handheld (DVB-H), a data broadcasting system known as media forward link only (MediaFLO) and integrated services digital broadcast-terrestrial (ISDB-T). The receiving of multicast signals may also be provided. Data received by the broadcast receiving module 111 may be stored in the memory 160, for example. The broadcasting receiving module 111 may be configured to cater not only to the above-mentioned digital broadcasting system but also to other broadcasting systems.

The mobile communication module 112 may communicate wireless signals with one or more network entities (e.g. a base station, an external terminal, a server). The signals may represent audio, video, multimedia, control signaling, and data, etc.

The wireless Internet module 113 may support Internet access for the mobile terminal 100. This wireless Internet module 113 may be internally or externally coupled to the mobile terminal 100. Suitable technologies for wireless Internet may include, but are not limited to, WLAN (Wireless LAN) (Wi-Fi), Wibro (Wireless broadband), Wimax (World Interoperability for Microwave Access), and/or HSDPA (High Speed Downlink Packet Access). The wireless Internet module 113 may be replaced with a wire Internet module in non-mobile terminals. The wireless Internet module 113 and the wire Internet module may be referred to as an Internet module.

The short-range communication module 114 is a module that may facilitate short-range communications. Suitable technologies for short-range communication may include, but are not limited to, radio frequency identification (RFID), infrared data association (IrDA), ultra-wideband (UWB), as well as networking technologies such as Bluetooth and ZigBee.

The position-location module 115 may identify or otherwise obtain a location of the mobile terminal 100. The position-location module 115 may be provided using global positioning system (GPS) components that cooperate with associated satellites, network components, and/or combinations thereof.

Referring to FIG. 1, the audio/video (A/V) input unit 120 may provide audio or video signal input to the mobile terminal 100. The A/V input unit 120 may include a camera 121 and a microphone 122. The camera 121 may receive and process image frames of still pictures and/or video. The processed image frames may be displayed on the display 151.

The image frames processed by the camera 121 may be stored in the memory 160 or may be transmitted to the outside through the wireless communication unit 110. At least two or more cameras 121 may be provided in the mobile terminal according to use environment.

The microphone 122 may receive an external audio signal while the mobile terminal is in a particular mode, such as a phone call mode, a recording mode and/or a voice recognition mode. The received audio signal may then be processed and converted into digital data.

The mobile terminal 100, and in particular the A/V input unit 120, may include a noise removing algorithm (or noise canceling algorithm) to remove noise generated in the course of receiving the external audio signal. Data generated by the A/V input unit 120 may be stored in the memory 160, utilized by the output unit 150, and/or transmitted via one or more modules of the wireless communication unit 110. At least two or more microphones and/or cameras may also be provided.

The user input unit 130 may generate input data responsive to user manipulation of an associated input device or devices. Examples of such devices may include a keypad, a dome switch, a touchpad (e.g., static pressure/capacitance), a jog wheel and/or a jog switch.

The sensing unit 140 may provide status measurements of various aspects of the mobile terminal 100. For example, the sensing unit 140 may detect an open/close status (or state) of the mobile terminal 100, a relative positioning of components (e.g., a display and a keypad) of the mobile terminal 100, a change of position of the mobile terminal 100 or a component of the mobile terminal 100, a presence or absence of user contact with the mobile terminal 100, and/or an orientation or acceleration/deceleration of the mobile terminal 100.

The mobile terminal 100 may be configured as a slide-type mobile terminal. In such a configuration, the sensing unit 140 may sense whether a sliding portion of the mobile terminal 100 is open or closed. The sensing unit 140 may also sense presence or absence of power provided by the power supply unit 190, presence or absence of a coupling or other connection between the interface unit 170 and an external device, etc. The sensing unit 140 may include a proximity sensor 141.

The output unit 150 may generate an output relevant to a sight sense, an auditory sense, a tactile sense and/or the like. The output unit 150 may include a display unit 151, an audio output module 152, an alarm unit 153 and a haptic module 154.

The display unit 151 may display (output) information processed by the terminal 100. For example, in case that the terminal is in a call mode, the display unit 151 may display a user interface (UI) or a graphic user interface (GUI) associated with a call. If the mobile terminal 100 is in a video communication mode or a photograph mode, the display unit 151 may display a photographed and/or received picture, a UI or a GUI.

The display unit 151 may include at least one of a liquid crystal display (LCD), a thin film transistor liquid crystal display (TFT LCD), an organic light-emitting diode (OLED), a flexible display, and a 3-dimensional display.

The display unit 151 may have a transparent or light-transmissive type configuration to enable an external environment to be seen through. This may be called a transparent display unit. A transparent OLED (TOLED) may be an example of a transparent display unit. A backside structure of the display unit 151 may also have the light-transmissive type configuration. In this configuration, a user may see an object located behind the terminal body through the area occupied by the display unit 151 of the terminal body.

At least two or more display units 151 may also be provided. For example, a plurality of display units may be provided on a single face of the terminal 100 by being built in one body or spaced apart from the single face. Alternatively, each of a plurality of display units may be provided on different faces of the terminal 100.

If the display unit 151 and a sensor for detecting a touch action (hereinafter referred to as a touch sensor) are constructed in a mutual-layered structure (hereinafter referred to as a touch screen), the display unit 151 may be used as an input device as well as an output device. For example, the touch sensor 142 may include a touch film, a touch sheet, a touchpad and/or the like.

The touch sensor 142 may convert a pressure applied to a specific portion of the display unit 151 or a variation of electrostatic capacity generated from a specific portion of the display unit 151 to an electric input signal. The touch sensor may detect a pressure of a touch as well as a position and size of the touch.

If a touch input is provided to the touch sensor 142, signal(s) corresponding to the touch input may be transferred to a touch controller. The touch controller may process the signal(s) and then transfer corresponding data to the controller 180. The controller 180 may therefore know which portion of the display unit 151 is touched.

Referring to FIG. 1, a proximity sensor 141 may be provided at an inner area of a mobile terminal wrapped by the touch screen or at a vicinity of the touch screen. The proximity sensor 141 is a sensor capable of detecting an object approaching a predetermined detection surface or whether there is an object nearby using an electromagnetic force or infrared, dispensing with a mechanical contact. The proximity sensor has a longer life than that of a contact sensor, such that its utility is higher.

Examples of the proximity sensor may include a transmissive photo sensor, direct reflective photo sensor, a minor reflective photo sensor, a high frequency oscillating proximity sensor, a capacitive proximity sensor, a magnetic proximity sensor, an infrared proximity sensor and the like. In the case the touch screen is capacitive type, the proximity of a pointer may be detected by changes of electric fields caused by proximity of the pointer. The touch screen (touch sensor) therefore may be classified as a proximity sensor.

For the convenience sake, a case where a pointer is recognized to be proximately placed on a touch screen without touching the touch screen is called a “proximity touch” and a case the pointer completely touches the touch screen is called a “contact touch”. The position proximity-touched by the pointer on the touch screen is a position vertically corresponded by the pointer to the touch screen when the pointer proximity-touches the touch screen.

The proximity sensor may detect the proximity touch and proximity touch pattern (e.g., proximity touch distance, proximity touch direction, proximity touch speed, proximity touch time, proximity touch position and proximity touch mobile state, etc.),Information corresponding to the detected proximity touch operation and proximity touch pattern may be displayed on the touch screen.

The audio output module 152 may output audio data that is received from the wireless communication unit 110 in a call signal reception mode, a call mode, a recording mode, a voice recognition mode, a broadcast receiving mode and/or the like. The audio output module 152 may output audio data stored in the memory 160. The audio output module 152 may output an audio signal relevant to a function(e.g., a call signal receiving sound, a message receiving sound, etc.) performed by the mobile terminal 100. The audio output module 152 may include a receiver, a speaker, a buzzer and/or the like.

The alarm unit 153 may output a signal for announcing an event occurrence of the mobile terminal 100. An event occurring in the mobile terminal 100 may include one of a call signal reception, a message reception, a key signal input, a touch input and/or the like. The alarm unit 153 may output a signal for announcing an event occurrence by way of vibration or the like as well as a video signal or an audio signal. The video signal may be outputted via the display unit 151. The audio signal may be outputted via the audio output module 152. The display unit 151 or the audio output module 152 may be classified as part of the alarm unit 153.

The haptic module 154 may bring about various haptic effects that can be sensed by a user. Vibration is a representative example for the haptic effect brought about by the haptic module 154. Strength and pattern of the vibration generated from the haptic module 154 may be controllable. For example, vibrations differing from each other may be outputted in a manner of being synthesized together or may be sequentially outputted.

The haptic module 154 may generate various haptic effects including a vibration, an effect caused by such a stimulus as a pin array vertically moving against a contact skin surface, a jet power of air via outlet, a suction power of air via inlet, a skim on a skin surface, a contact of an electrode, an electrostatic power and the like, and/or an effect by hot/cold sense reproduction using an endothermic or exothermic device as well as the vibration.

The haptic module 154 may provide the haptic effect via direct contact. The haptic module 154 may enable a user to experience the haptic effect via muscular sense of a finger, an arm and/or the like. Two or more haptic modules 154 may be provided according to a configuration of the mobile terminal 100.

The memory 160 may store a program for operations of the controller 180. The memory 160 may temporarily store input/output data (e.g., phonebook, message, still picture, moving picture, etc.). The memory 160 may store data of vibration and sound in various patterns outputted in case of a touch input to the touch screen.

The memory 160 may include at least one of a flash memory, a hard disk, a multimedia card micro type memory, a card type memory (e.g., SD memory, XD memory, etc.), a random access memory (RAM), a static random access memory (SRAM), a read-only memory (ROM), an electrically erasable programmable read-only memory, a programmable read-only memory, a magnetic memory, a magnetic disk, an optical disk, and/or the like. The mobile terminal 100 may operate in association with a web storage that performs a storage function of the memory 160 in the Internet.

The interface unit 170 may play a role as a passage to external devices connected to the mobile terminal 100. The interface unit 170 may receive data from an external device. The interface unit 170 may be supplied with a power and then the power may be delivered to elements within the mobile terminal 100.

The interface unit 170 may enable data to be transferred to an external device from an inside of the mobile terminal 100. The interface unit 170 may include a wire/wireless headset port, an external charger port, a wire/wireless data port, a memory card port, a port for coupling to a device having an identity module, an audio input/output (I/O) port, a video input/output (I/O) port, an earphone port and/or the like.

The identity module may be a chip or card that stores various kinds of information for authenticating use of the mobile terminal 100. The identify module may include a user identity module (UIM), a subscriber identity module (SIM), a universal subscriber identity module (USIM) and/or the like. A device provided with the above identity module (hereinafter referred to as an identity device) may be manufactured in the form of a smart card. The identity device may be connected to the mobile terminal 100 via the port.

The interface unit 170 may play a role as a passage for supplying a power to the mobile terminal 100 from a cradle that is connected to the mobile terminal 100. The interface unit 170 may play a role as a passage for delivering various command signals, which are inputted from the cradle by a user, to the mobile terminal 100. Various command signals inputted from the cradle or the power may work as a signal for recognizing that the mobile terminal 100 is correctly loaded in the cradle.

The controller 180 may control overall operations of the mobile terminal 100. For example, the controller 180 may perform control and processing relevant to a voice call, a data communication, a video conference and/or the like. The controller 180 may have a multimedia module 181 for multimedia playback. The multimedia module 181 may be implemented within the controller 180 or may be configured separately from the controller 180.

The controller 180 may perform pattern recognizing processing for recognizing a handwriting input performed on the touch screen as a character an/or recognizing a picture drawing input performed on the touch screen as an image.

The power supply unit 190 may receive an external or internal power and then supply the power required for operations of the respective elements under control of the controller 180.

Embodiments of the present disclosure explained in the following description may be implemented within a recording medium that can be read by a computer or a computer-like device using software, hardware or combination thereof.

According to the hardware implementation, arrangements and embodiments may be implemented using at least one of application specific integrated circuits (ASICs), digital signal processors (DSPs), digital signal processing devices DSPDs), programmable logic devices (PLDs), field programmable gate arrays (FPGAs), processors, controllers, microcontrollers, microprocessors and electrical units for performing other functions. In some cases, embodiments may be implemented by the controller 180.

For a software implementation, arrangements and embodiments described herein may be implemented with separate software modules, such as procedures and functions, each of which may perform one or more of the functions and operations described herein. Software codes may be implemented with a software application written in any suitable programming language and may be stored in memory such as the memory 160, and may be executed by a controller 180 or processor.

Now, the constituent elements for accomplishing the idea of the present disclosure out of the constituent elements of the mobile terminal of FIG. 1 will be described in the following.

A mobile terminal 100-1 calculating carbon emission of a mobile terminal user according to an exemplary embodiment illustrated in FIG. 2 may include a controller 180-1 configured to calculate carbon emission caused by the user and output the carbon emission to the display unit, and a memory 160-1 storing information necessary for calculating the carbon emission or a result calculated therefrom. Furthermore, the mobile terminal 100-1 may further include a user input unit 130-1 receiving the information necessary for calculating the carbon emission according to user manipulation. A display unit 150-1 may be a touch screen, and may receive information necessary for calculating the carbon emission through the touch screen.

The controller 180-1 may use a power usage based on battery consumption of the mobile terminal as one of items for calculating the carbon emission to thereby calculate the carbon emission. The controller 180-1 may perform usage input relative to carbon emission calculation item set-up and each carbon emission calculation item via the display unit 150-1 and the user input unit 130-1.

The controller 180-1 may extract information related to carbon emission from an image captured by the camera module (121 of FIG. 1). For example, in a case a user receives a paper receipt in which the carbon emission is described in a text format or a bar code format based on purchase of goods or service (i.e., in case of receiving a carbon receipt), the user may use the camera module to capture the text or bar code described on the receipt, and the controller 180-1 may perform an image processing relative to the text/bar code including the captured carbon emission information to read out the carbon emission.

At this time, the memory 160-1 is stored with information (LOOK UP TABLE) necessary for calculating a pre-set carbon emission based on user activity (e.g., time of having used electric equipment, usage per unit goods, time of having used public transportation, and purchased price of sundry goods for everyday life) for each carbon emission calculation. Therefore, the controller 180-1 may compare the user activity inputted per carbon emission calculation with the information (LOOK UP TABLE) necessary for calculation of carbon emission pre-stored in the memory 160-1.

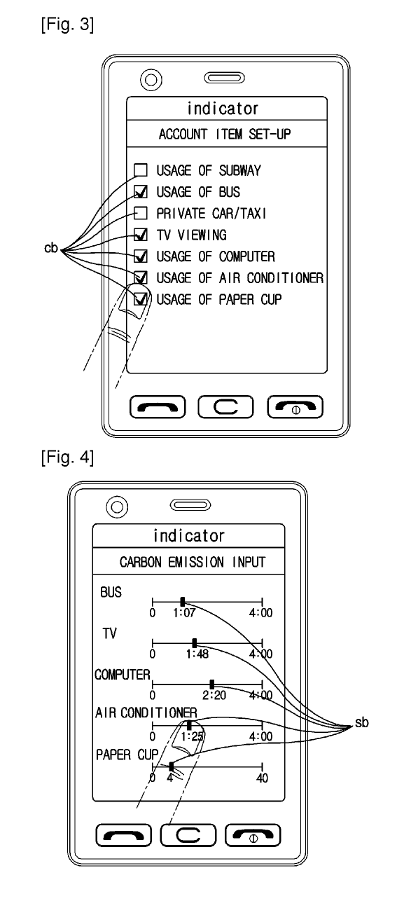

FIG. 3 is a screen of a display unit on a mobile terminal that sets up carbon emission calculation item.

The mobile terminal in FIG. 3 is formed with a touch screen, and a controller displays all activity items of a user that emits carbon dioxide along with each check box. Referring to FIG. 3, the carbon emission calculation items include usage time of public transportation such as subways, buses and private cars, usage time of electronic appliances such as TVs/computers and usage (usage frequency) of disposable products such as paper cups and the like. The mobile terminal user may determine items to be monitored for carbon emission by touching each check box under carbon emission calculation items desired by the user.

FIG. 4 is a screen of a display unit on a mobile terminal that inputs carbon emission relative to carbon emission calculation item. That is, FIG. 4 is an image view illustrating a screen of the display unit of the mobile terminal into which usage of carbon emission calculation items set up in FIG. 3 is inputted.

In a case the mobile terminal user performs a behavior corresponding to each of the carbon emission calculation items that is to be monitored, the user may activate a carbon emission input screen of FIG. 4, touch-drag a bar (sb) that indicates usage of each of the carbon emission calculation items and personally input the usage (an amount of usage).

Referring to FIG. 4, the means of transportation or the electronic appliances may be inputted as usage times, while the disposable products may be inputted as the number of usage.

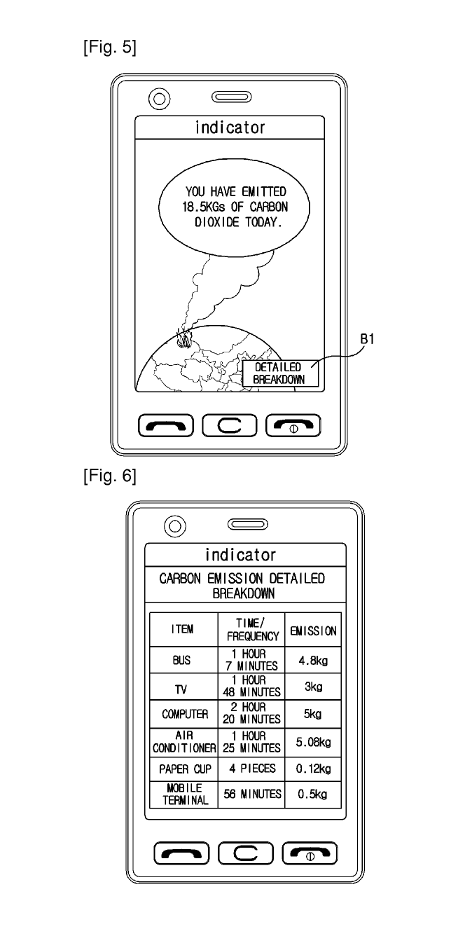

FIG. 5 is a screen of a display unit on a mobile terminal that warns carbon emission.

Referring to FIG. 5, the controller may calculate the carbon emission based on usage inputted from FIG. 4, and display a warning screen described with a total amount of carbon emissions caused by each of the carbon emission monitoring items on the display unit. The user may recognize the warning screen, and touch a detailed breakdown touch button (B1) to check the detailed breakdown of the total carbon emissions by the user.

FIG. 6 is a screen of a display unit on a mobile terminal that outputs a detailed breakdown of carbon emission. That is, FIG. 6 is an image view illustrating a screen of the display unit on the mobile terminal that outputs a detailed breakdown of daily carbon emission by the user in a case the detailed breakdown touch button (B1) of FIG. 5 is touched.

The described detailed breakdown screen of carbon emission may include usage of each carbon emission monitoring items and carbon emission resultant therefrom. The intrinsic carbon emission of the mobile terminal among the carbon emission monitoring items illustrated in FIG. 6 may be automatically calculated and displayed without user input of FIG. 4 by utilizing use time information of secondary battery in the mobile terminal.

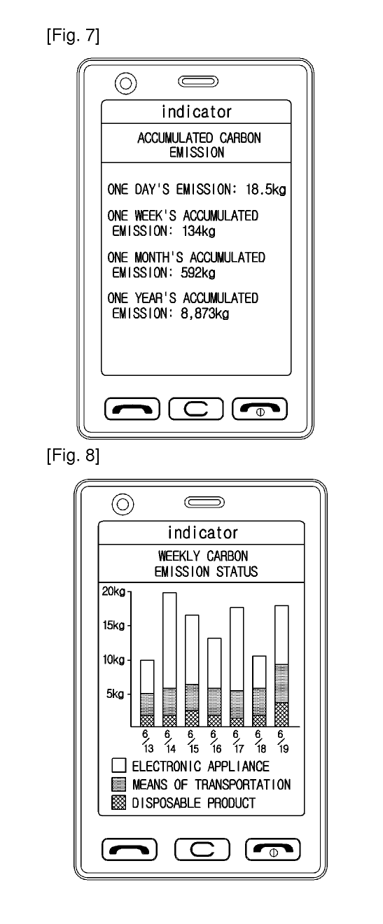

FIG. 7 is an image view of a screen of a display unit on a mobile terminal that outputs an accumulated carbon emission of a mobile terminal user.

Referring to FIG. 7, the controller may use the calculated carbon emission information to display on the display unit the carbon emission in a daily accumulation unit, a weekly accumulation unit, a monthly accumulation unit and a yearly accumulation unit.

FIG. 8 is a screen of a display unit on a mobile terminal that outputs a graph indicating a weekly carbon emission status.

Although the illustrated graph is a bar type graph, the type is not limited thereto and any type of graph may be used in a matter-of-course manner. The illustrated bar type graph may distinctively and visually display the weekly carbon emission status based on ratio of amount of carbons discharged per user activity item.

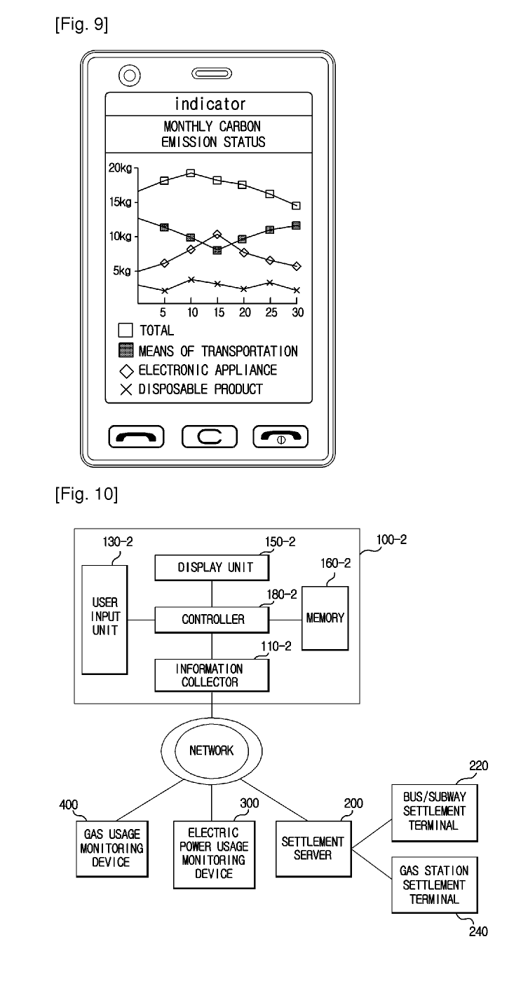

FIG. 9 is a screen of a display unit on a mobile terminal that outputs a graph indicating a monthly carbon emission status.

Although the illustrated graph is a folded line-type graph, the type is not limited thereto and any type of graph may be used in a matter-of-course manner. The illustrated graph uses a plurality of folded lines to display a total carbon emission and the carbon emission per detailed breakdown, where each detailed breakdown is grouped per type.

FIG. 10 is a block diagram illustrating a mobile terminal and information collection structure according to still another exemplary embodiment of the present disclosure.

A mobile terminal 100-2 calculating the carbon emission by the user of FIG. 10 may include a display unit 150-2 providing information to the user, a controller 180-2 calculating carbon emission caused by the mobile terminal user and outputting the calculated carbon emission to the display unit 150-2, a memory 160-2 storing information necessary for calculating the carbon emission or a calculation result, and an information collector 110-2 receiving usage information for each carbon calculation item from an outside server. The mobile terminal 100-2 may further include a user input unit 130-2 receiving information necessary for calculating carbon emission based on user manipulation or a user instruction.

The controller 180-2 may calculate the carbon emission based on intrinsic use of the mobile terminal as one item of the carbon emissions. The carbon emission by the mobile terminal may be calculated by power usage resultant from battery consumption.

The controller 180-2 may receive the information on carbon emission by the user from the information collector 110-2. The controller 180-2 may use the display unit 150-2 and the user input unit 130-2 to receive a carbon emission item set-up and use information on each carbon emission item, as in the case of FIG. 2. The information collector 110-2 of the mobile terminal may include a module that performs the wireless data communication.

Referring again to FIG. 10, the information collector 110-2 may receive settlement information related to carbon emission from an outside settlement server (e.g., electronic money card settlement servers such as a credit card settlement server and a traffic card) through a network (e.g., Internet). That is, the information collector 110-2 may receive from a settlement server 200 the settlement breakdown relative to purchase activities that cause carbon emission among the settlement breakdown relative to purchase activities of goods or services by the user.

For example, the information collector 110-2 may receive from the settlement server 200 the breakdown that has performed settlement of fueling by using a gas station settlement mobile terminal 240 of the mobile terminal user. The received fuel is supposed to be combusted by a car or the like, and the controller 180-2 may calculate the carbon emission resultant from the relevant fueling as an amount of received fuel and an amount of generated carbon dioxide.

For example, the information collector 110-2 may receive via the settlement server 200 the breakdown settled by his or her credit card or traffic card relative to a traffic card settlement terminal 220 disposed at a bus or a subway. The controller 180-2 may know the traffic means/section the user has used by the traffic card settlement breakdown, and calculate the carbon emission caused by the user using the traffic card settlement breakdown. For example, the information collector 110-2 may receive an air ticket purchase breakdown from the settlement server 200.

Furthermore, the information collector 110-2 may receive operation status information of electronic appliances positioned on a site (e.g., a user house) from a power usage monitoring device 300 disposed at the site designated by the mobile terminal user. At this time, the operation status information may include whether each electric appliance is operating and an operation level (e.g., strength/weakness of vacuum cleaner). The power usage monitoring device 300 may be a so-called smart meter that grasps the detailed power usage of a household and informs the power usage to the user or the power provider.

The information collector 110-2 may receive information on gas usage at the site, from a gas usage monitoring device 400 disposed at the site (e.g., a user house) designated by the mobile terminal user. The information collector 110-2 may also receive information on a warming status (e.g., warming temperature and/or warming time) of the site, from a device monitoring the warming status at the site (e.g., a user house) designated by the mobile terminal user.

The controller 180-2 may calculate the carbon emission caused by each activity, from the power usage, gas usage and site warming status. For example, an operation time of each electronic appliance is multiplied by a weight based on operation level, and again multiplied by environment influence index relative to manufacturing/disposal of relevant electronic appliances to calculate the carbon emission.

Meanwhile, the controller 180-2 may use the information on the power usage breakdown (used amount or fee) and gas usage breakdown (used amount or fee), manage the calculated carbon emission information on daily, weekly and monthly bases, and display the information on the display unit. The controller 180-2 may use the power usage information received from the information collector 110-2 via the power usage monitoring device 300 (e.g., the smart meter) to calculate the carbon emission, and generate a control command for controlling the electronic appliances, transmit the control command to the power usage monitoring device 300 (e.g., the smart meter) and to control the electronic appliances based on the carbon emission, if the carbon emission exceeds a predetermined reference level according to the daily, weekly and monthly bases.

Meanwhile, the controller 180-2, as shown in FIGS. 3 and 4, may display the carbon emission calculation items on the display unit and the user may input usage of each carbon emission calculation item. The controller 180-2 may also display carbon emission calculation results in various manners on the display unit 150-2, as depicted in FIGS. 5 through 9.

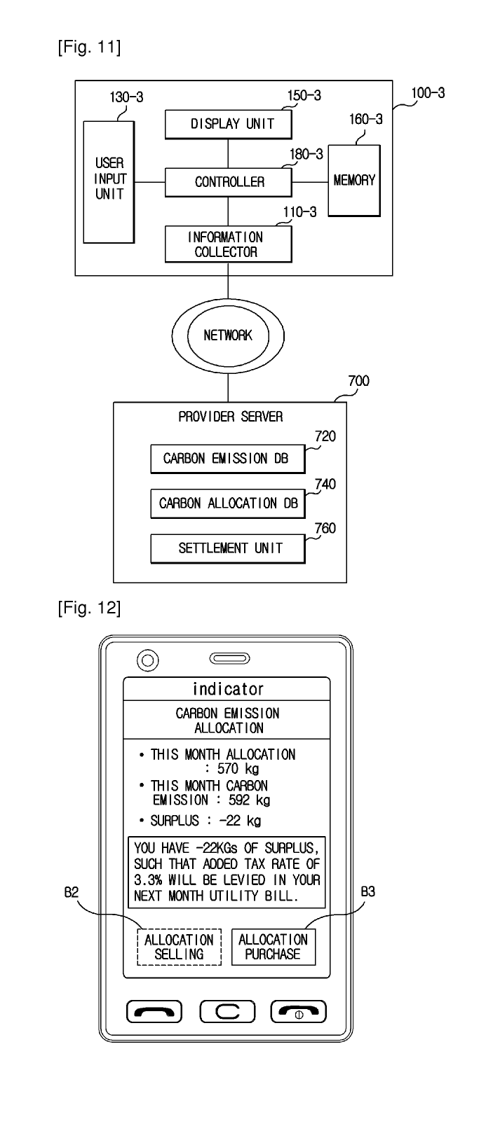

FIG. 11 is a block diagram illustrating a mobile terminal and information collection structure according to still further exemplary embodiment of the present disclosure.

A mobile terminal 100-3 calculating carbon emission of the mobile terminal user illustrated in FIG. 11 may include a display unit 150-3 providing information to the user, a controller 180-3 calculating carbon emission caused by the mobile terminal user and outputting the calculated carbon emission to the display unit 150-3, a memory 160-3 storing information necessary for calculating the carbon emission, and an information collector 110-3 receiving information necessary for calculating carbon emission from outside. Furthermore, the mobile terminal 100-3 may further include a user input unit 130-3 that receives information necessary for calculating the carbon emission based on user manipulation or a user instruction.

The controller 180-3, similar to the case in FIG. 10, may calculate carbon emission, from information on the settlement breakdown, power usage breakdown and gas usage breakdown of the mobile terminal user.

Now, an exemplary embodiment of a carbon emission management server according to the present disclosure may be a provider server 700 of a carbon emission management provider that manages the carbon emission and relays the trading of the carbon emission.

That is, the provider server 700 performs the function of calculating the caused carbon emission from the information on the settlement breakdown, the power usage breakdown and the gas usage breakdown of purchase of goods or service that causes carbon emission of the mobile terminal user. In this case, the controller 180-3 of the mobile terminal may receive via the information collector 110-3 the calculation result of carbon emission performed by the provider server 700. In this case, the mobile terminal user is also allocated with (amount of) carbon emission that is dischargeable during a predetermined period (e.g., one month), which may be called the carbon emission right. Furthermore, the exceeded or un-used or surplus amount of carbon emission may cause an economic burden or benefit.

The carbon emission management server (hereinafter referred to as provider server, 700) may include a carbon emission DB (database) 720 storing information on carbon emission per user, a carbon allocation DB 740 storing information on carbon emission allocated to each user, and a settlement unit 760 supporting process of carbon emission of the user and supporting trading of carbon emission of the user. The settlement unit 760 may manage the carbon allocation in the form of, for example, carbon emission account for managing the carbon emission allocated to the user.

In a case the carbon emission discharged by the user exceeds an amount allocated to the user during a predetermined period (e.g., one month), the provider server 700 may advise the exceeded amount to the user. The provider server 700 may increase a next month utility (or gas) bill as much as the exceeded amount of carbon emission, and may decrease a next month utility (or gas) bill as much as the reduced amount of carbon emission. Furthermore, the provider server 700 may request the user to buy insufficient carbon emission or to sell extra carbon emission. To this end, the provider server 700 may include an electronic trade relay module that is capable of performing the electronic commercial trading of carbon emissions among individuals.

FIG. 12 is an image view of a screen of a display unit on a mobile terminal that outputs carbon emission allocation and accumulated emission of a mobile terminal user.

As illustrated in FIG. 12, the mobile terminal may output a carbon emission, and allocated carbon emission of the mobile terminal user for a predetermined period (e.g., one month), and also output a difference therebetween. The mobile terminal may also inform the user of an effect provided to the utility bill caused by the difference.

The controller may display a carbon emission allocation selling button (B2) and a purchase button (B3) on the display unit in order for the user to output a carbon emission allocation trade screen if the mobile terminal user wishes to sell or purchase the allocation. Referring to FIG. 12, only the carbon emission allocation purchase button (B3) is activated, because the carbon emission allocation is insufficient.

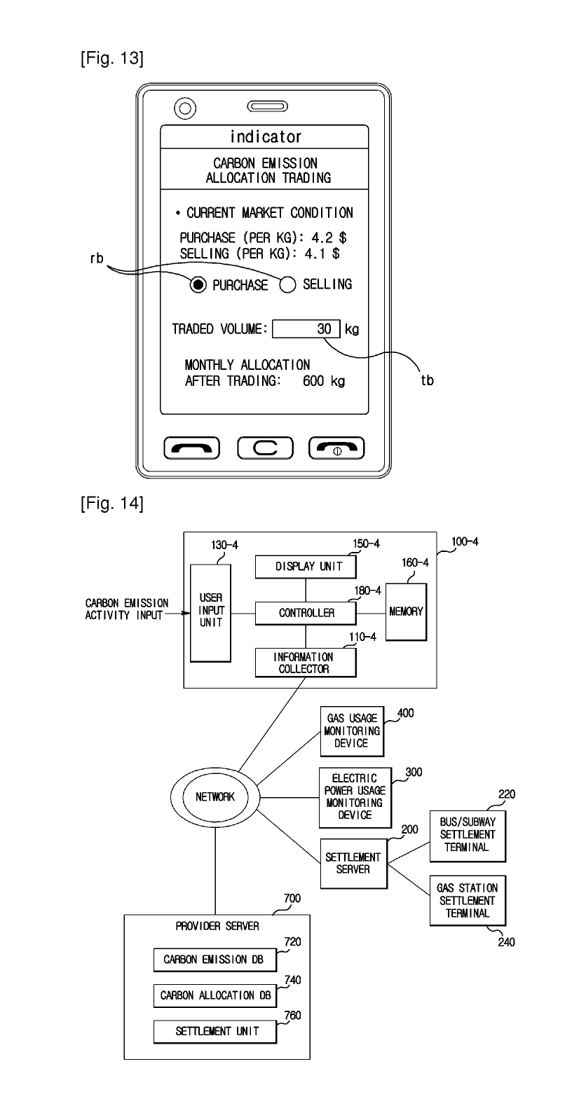

FIG. 13 is an image view of a screen of a display unit on a mobile terminal that performs carbon emission allocation trading.

A controller may divide a carbon emission allocation price into a purchase price and a selling price, and display the price on the display unit, and display the carbon emission allocation of the mobile terminal user for a predetermined period (e.g., one month) after the trading. The controller may also display on the display unit radio buttons (rb) capable of selecting purchase or selling and/or an input window capable of inputting the trade volume, so that the mobile terminal user can trade the carbon emission allocation.

FIG. 14 is a block diagram illustrating a carbon emission management server and information collection structure according to still further exemplary embodiment of the present disclosure.

As shown in FIG. 14, the carbon emission management server (hereinafter referred to as provider server) according to an exemplary embodiment of the present disclosure may be associated with an outside server having information on carbon emission through the settlement server 200, the power usage monitoring device 300 and the gas usage monitoring device 400 via a network (wireless and/or wired method, and a mobile terminal capable of receiving information on the carbon emission of the user.

That is, the provider server 700 may receive through the settlement server 200 a settlement breakdown (the breakdown may be carbon emission receipt generated by the settlement server) of purchase activity causing carbon emission among settlement breakdowns on purchase activity of goods or service by the user. Meanwhile, the provider server 700 may use the settled breakdown information on the transmitted purchase activity of goods or service by the user to issue a carbon emission receipt.

The carbon emission receipt may be issued in the form of electronic receipt, and a controller (not shown) of the provider server 700 may store the carbon emission receipt (which is an electronic receipt) in the carbon emission DB 720, and transmit the receipt to the mobile terminal 100-3 through the network.

In this case, because the carbon emission receipt contains all the carbon emissions caused by each purchase activity by the user, the mobile terminal 100-3 can obtain the carbon emission without recourse to separate calculation. Furthermore, the controller 180-3 of the mobile terminal 100-3 may display the transmitted carbon emission receipt on the display unit 150-3, or extract the carbon emission items included in the carbon emission receipt and carbon emissions and display the extraction on the display unit. Therefore, the user may know the information on the carbon emissions caused by user activity in real time.

In other exemplary embodiment of the present disclosure, the mobile terminal 100-3 may request an access right to reception and display of the carbon emission receipt which is the electronic receipt. In this case, the mobile terminal 100-3 may be formed with an electronic signature software module, or a certification smart chip for checking the access right.

Furthermore, the provider server 700 may receive a power usage breakdown per user (power usage or fee) or a gas usage breakdown per user (gas usage or fee) that causes carbon emission through the power usage monitoring device 300 and the gas usage monitoring device 400 to calculate the carbon emission. In this case, the provider server 700 may calculate a carbon emission estimate of the current unit power usage (fee), calculate in daily, weekly, monthly and yearly bases and store/manage the estimate in and by the carbon emission DB 720, because the power usage (fee) is periodically received.

Furthermore, the power usage breakdown for each user may include information on power usage of whether carbon is used or not. For example, in the method of generating electric power, carbon emission is enormous in case of using fossil fuels such as coal and petroleum, and carbon emission is nil in case of using sunlight, wind or tidal wave, such that information on power usage based on whether carbon is utilized or not is used to calculate the carbon emission. At this time, the information of carbon emission based on power usage may be managed per user, and particularly, may be managed per user group (e.g., per family) to calculate the carbon emission of a group.

A controller (not shown) of the provider server 700 may use the received power usage breakdown per user (power usage or fee) and the gas usage breakdown per user (gas usage or fee) and transmit information on the calculated carbon emission to the mobile terminal. Therefore, the user may simply and easily check the information on the carbon emission he or she has emitted based on usage of electric power or gas.

At this time, a mobile terminal 100-4 of FIG. 14 may include all the features of mobile terminals explained in FIGS. 2, 10 and 11. That is, an illustrated controller of the mobile terminal may implement at least one of the functions of calculating carbon emission from usage input by the user relative to carbon emission items, calculating carbon emission from settlement breakdown relative to purchase activity that causes carbon emission and obtaining carbon emission from the carbon emission receipt transmitted from an outside provider server.

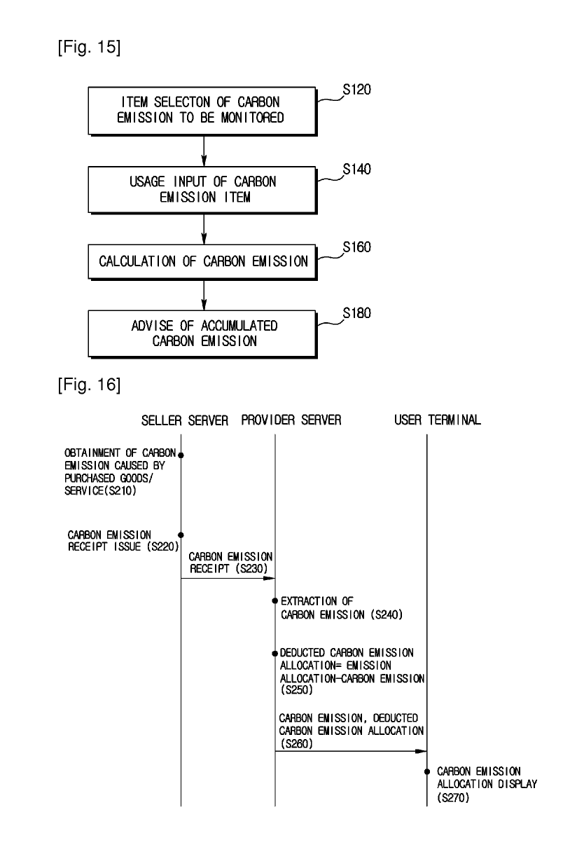

FIG. 15 is a flowchart illustrating a carbon emission monitoring method according to an exemplary embodiment of the present disclosure.

An illustrated carbon monitoring method may include selecting carbon emission items to be monitored (S120), receiving usage of the carbon emission items (S140), calculating the carbon emission based on the usage (S160), and informing accumulated carbon emission for a predetermined period (S180).

In case of FIG. 2, the step of S120 may use a screen of the display unit illustrated in FIG. 3, and the step of S140 may be implemented by input of usage of the carbon emission items by the user through the user input unit 130-1, using the screen of the display unit of FIG. 4.

The step of S140 in FIG. 10 may be implemented by receipt from the outside settlement server 200 and/or power/gas usage monitoring devices 300, 400 connected via the network. The step of S160 in FIG. 11 may be implemented by receipt of usage on carbon emission items from the outside provider server connected to the network. Furthermore, FIG. 11 subsequent to S180 may further include comparing the accumulated carbon emission with the carbon emission allocation, informing an effect from a difference between the accumulated carbon emission and the carbon emission allocation, and purchasing or selling the carbon emission allocation.

The step of informing the effect from the difference between the accumulated carbon emission and the carbon emission allocation may use the screen of the display unit in FIG. 12. The step of purchasing or selling the carbon emission allocation may use the screen of the display unit in FIG. 13.

Furthermore, the step of using the carbon emission receipt (electronic receipt) in FIG. 11 may omit the steps of S120, S140 and S160, and may be replaced by receipt of carbon emission receipt from an outside server via a wired or wireless network.

The carbon emission receipt may be utilized by the carbon emission management method in a flowchart illustrated in FIG. 16. The illustrated carbon emission management method may be implemented with a focus on the provider server 700 of FIG. 14. The illustrated carbon emission management method that includes processes implemented by a seller server of goods or service may include obtaining carbon emission caused by goods or service purchased by the user (S210), issuing a carbon emission receipt described with the carbon emission by the seller server (S220), and transmitting the carbon emission receipt to the carbon emission management provider server (S230).

The illustrated carbon emission management method that includes processes implemented by the carbon emission management provider server may include receiving the carbon emission receipt issued based on purchase of goods or service by the user (S230), extracting carbon emission from the transmitted carbon emission receipt (S240), deducting the extracted carbon emission from the carbon emission allocation of the user per unit period (S250), and transmitting the carbon emission and deducted carbon emission allocation from the carbon emission management provider server to the user terminal (S260).

The illustrated carbon emission management method which is a process implemented by the user terminal may further include displaying the transmitted carbon emission allocation (S270).

The steps of S210 through S270 may be embodied by procedures similar to part of those described in FIGS. 1 through 15. For example, the carbon emission trading as described in FIGS. 12 and 13 may be implemented subsequent to S270.

The above-mentioned technical ideas according to the present disclosure, however, be embodied in many different forms and should not be construed as limited to the embodiments set forth herein. While particular features or aspects may have been disclosed with respect to several embodiments, such features or aspects may be selectively combined with one or more other features and/or aspects of other embodiments as may be desired.

For example, although the present disclosure has been embodied by a mobile terminal, a user interface such as a digital TV, a laptop or a computer may be used, and/or other terminals connectible to wired/wireless networks may be applied, and it should be apparent that these cases all belong to the right scope of the present disclosure.

The present disclosure has an industrial applicability in that a terminal can be provided that calculates and accumulates carbon dioxide emission caused by activities of terminal user by receiving information on carbon emission from a user input unit or an outside server that generates information related to carbon emission.

Although the present disclosure has been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

The present disclosure may provide a terminal configured to calculate carbon emission, and more particularly to a terminal configured to calculate and accumulate carbon dioxide (Co²) emission caused by activity of a terminal user.

1. A terminal comprising:
a display unit configured to display information that is processed;
a user input unit configured to input information on amount of carbon emission;
a storage stored with information on the amount of carbon emission inputted through the user input unit and a program for calculating the amount of carbon emission; and
a controller configured to calculate the amount of carbon emission based on usage of carbon emission and to display the amount of carbon emission on the display unit.

2. The terminal of claim 1, wherein the information on the usage of carbon emission is usage information per item that emits carbon based on user activity,
wherein the controller uses the usage information per item to calculate carbon emission per item, calculates an accumulated carbon emission per item for at least one period of a day period, a weekly period and a yearly period, and controllably displays the accumulated carbon emission.

3. The terminal of claim 1, further comprising:
a camera module configured to capture a carbon receipt that lists the carbon emission in a text or a bar code format,
wherein the controller calculates carbon emission relative to information related to the carbon emission read out by a text image or a bar code image captured by the camera module and controllably displays the carbon emission on the display unit.

4. The terminal of claim 1, further comprising information collector configured to receive information necessary for calculating the carbon emission from an outside server.

5. The terminal of claim 4, wherein the outside server is a settlement server that generates an electronic-type carbon emission receipt containing settlement breakdown information on purchase of goods or service that causes, by a user, the carbon emission,
wherein the controller calculates the carbon emission in real time using the settlement breakdown information in the carbon emission receipt received from the information collector and controllably displays the calculation on the display unit.

6. The terminal of claim 4, wherein the outside server is an electric power use monitoring device configured to generate information on power usage in a household, or a gas use monitoring device configured to generate information on gas usage in a household,
wherein the controller uses the information on power usage or the gas usage received from the information collector to calculate carbon emission in real time and to display the calculated carbon emission on the display unit.

7. The terminal of claim 6, wherein the electric power use monitoring device configured to generate information on power usage in a household is a smart meter,
wherein the controller uses the information on the power usage received through the information collector from the smart meter to calculate the carbon emission, and generates a control command for controlling power equipment and transmits the control command to the smart meter, if the carbon emission exceeds a predetermined daily, weekly and monthly reference value.

8. A carbon emission management server comprising:
a carbon emission database configured to receive at least one of settlement breakdown, power usage breakdown and gas usage breakdown per user from an outside server to calculate information on carbon emission per user on daily, weekly, monthly and yearly bases and to store/manage the information;
a carbon emission allocation database configured to store/manage the information on carbon emission allocation per user in an account format based on carbon emission per user; and
a controller configured to controllably transmit the information on the carbon emission allocation per user in an account format to a terminal of the user.

9. The server of claim 8, wherein the settlement breakdown per user is an electronic-type carbon emission receipt relative to purchase of goods or service that causes carbon emission per user generated by an outside settlement server.

10. The server of claim 8, wherein the power usage breakdown per user includes power usage information based on whether carbon is used, and wherein the carbon emission database uses the power usage information based on whether the carbon is used to calculate the carbon emission.

11. A carbon emission monitoring method comprising:
receiving information on carbon emission usage;
calculating carbon emission based on the carbon emission usage; and
displaying the carbon emission on a display unit.

12. The method of claim 11, wherein the information on carbon emission usage is usage information per item that emits carbon based on user activity, and
the step of calculating the carbon emission based on the carbon emission usage includes using the usage information per item to calculate carbon emission per item and to calculate an accumulated carbon emission per item during any one period of daily, weekly, monthly and yearly periods.

13. The method of claim 11, wherein the step of receiving information on carbon emission usage includes using a camera module to obtain a carbon receipt image in which the carbon emission is described in a text or bar code format, and
the step of calculating the carbon emission based on carbon emission usage includes calculating carbon emission relative to information related to the carbon emission read out from a text image or a bar code image.

14. The method of claim 11, wherein the step of receiving information on the carbon emission usage includes receiving information necessary for calculating carbon emission from an outside server.

15. The method of claim 14, wherein the outside server is a settlement server that generates an electronic-type carbon emission receipt containing settlement breakdown information on purchase of goods or service that causes, by a user, the carbon emission, and
the step of calculating carbon emission based on carbon emission usage includes using the received settlement breakdown information on the carbon emission receipt to calculate the carbon emission in real time.

16. The method of claim 14, wherein the power usage monitoring device generating information on power usage in a household is a smart meter, and the step of calculating carbon emission based on carbon emission usage includes calculating carbon emission using the power usage information received from the smart meter, and
the carbon emission monitoring method further includes:
generating a control command for controlling power equipment; and
transmitting the control command to the smart meter, if the calculated carbon emission exceeds predetermined daily, weekly and monthly reference values.

17. A carbon emission monitoring method comprising:
receiving at least one of settlement breakdown, power usage breakdown and gas usage breakdown per user from an outside server to calculate information on carbon emission per user on daily, weekly, monthly and yearly bases and to store/manage the information;
storing/managing the information on carbon emission allocation per user in an account format based on carbon emission per user; and
transmitting the information on the carbon emission allocation per user in an account format to a terminal of the user.

18. The method of claim 17, wherein the settlement breakdown per user is an electronic-type carbon emission receipt relative to purchase of goods or service that causes carbon emission per user generated by an outside settlement server.

19. The method of claim 17, wherein the step of storing/managing the information on carbon emission allocation per user in an account format based on carbon emission per user includes deducting the calculated carbon emission per user from a predetermined carbon emission allocation per user.

20. The method of claim 17, wherein the power usage breakdown per user includes power usage information based on whether to use carbon, and wherein the carbon emission database uses the power usage information based on whether to use carbon to calculate the carbon emission.
